(19) United States
(12) Patent Application Publication
(10) Pub. No.: US 2025/0348824 A1
(43) Pub. Date: Nov. 13, 2025

(54) SYSTEM AND METHOD FOR DYNAMICALLY ANALYZING ONLINE MEETING METADATA IN REAL-TIME

(71) Applicant: Sunshine in Interaction, Wien (AT)

(72) Inventors: Thomas Spielhofer, Wien (AT); Lorenz Glatz, Wien (AT)

(21) Appl. No.: 19/205,445

(22) Filed: May 12, 2025

Related U.S. Application Data
(60) Provisional application No. 63/645,293, filed on May 10, 2024.

(51) Int. Cl. G06Q 10/0639; G10L 15/04; G10L 21/0272; H04L 65/403

(52) U.S. Cl. CPC G06Q 10/06393; G10L 15/04; G10L 21/0272; H04L 65/403

(57) ABSTRACT

A system for dynamically generating and analyzing metadata for online meetings is provided. The system is programmed to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyze the diarization information to calculate one or more key performance indicators; and e) generate visualization of the key performance indicators to be displayed to one or more participants in the online meeting.

### CROSS REFERENCE TO RELATED APPLICATIONS

This application claims priority to U.S. Provisional Patent Application No. 63/645,293, filed May 10, 2024, which is hereby incorporated by reference in its entirety.

### BACKGROUND

The field of the invention relates generally to generating and analyzing metadata for online meetings.

As their quality has improved over time online meetings have become increasingly prevalent in various domains, facilitating communication and collaboration among geographically dispersed participants. At the same time online meetings reduce our ability to experience and participate in non-verbal communication, a key component of any human interaction. Existing methods for analyzing the data generated during these meetings are not yet able to substitute for this deficiency, even more so when it comes to providing insights into group dynamics, group behavior and meeting efficiency.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a system for dynamically generating and analyzing metadata for online meetings is provided. The system includes a computer device includes at least one processor in communication with at least one memory device. The at least one memory device stores computer-implemented instructions that cause the at least one processor to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyze the diarization information to calculate one or more key performance indicators; and e) generate visualization of the key performance indicators to be displayed to one or more participants in the online meeting. The system may have additional, less, or alternate functionalities, including those discussed elsewhere herein.

In another aspect, a computer device for dynamically generating and analyzing metadata for online meetings is provided. The computer device includes at least one processor in communication with at least one memory device. The at least one memory device stores computer-implemented instructions that cause the at least one processor to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyze the diarization information to calculate one or more key performance indicators; and e) generate visualization of the key performance indicators to be displayed to one or more participants in the online meeting. The computer device may have additional, less, or alternate functionalities, including those discussed elsewhere herein.

In another aspect, a computer-implemented method for dynamically generating and analyzing metadata for online meetings is provided. The method is implemented on a computer device including at least one processor in communication with at least one memory device. The computer-implemented method includes: a) receiving at least one stream of at least one of audio and video of an online meeting, wherein the at least one stream includes one or more participants participating in the online meeting; b) extracting a plurality of metadata from the at least one stream; c) performing diarization on the at least one stream and the plurality of metadata the at least one stream to generate diarization information, wherein the diarization information includes information about participation for the one or more participants in the online meeting; d) analyzing the diarization information to calculate one or more key performance indicators; and e) generating visualization of the key performance indicators to be displayed to one or more participants in the online meeting. The system may have additional, less, or alternate functionalities, including those discussed elsewhere herein.

In one aspect, a system for dynamically generating and analyzing metadata for online meetings is provided. The system includes a computer device comprising at least one processor in communication with at least one memory device. The at least one memory device stores computer-implemented instructions that cause the at least one processor to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyzing the diarization information to calculate one or more key performance indicators; and e) generate visualization of the key performance indicators to be displayed to one or more participants in the online meeting. The system may have additional, less, or alternate functionalities, including those discussed elsewhere herein.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The Figures described below depict various aspects of the systems and methods disclosed. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements presently discussed, it being understood, however, that the present embodiments are not limited to the precise arrangements.

FIG. 1 illustrates a timing diagram for a process for dynamically generating and analyzing metadata for online meetings in real-time, in accordance with at least one embodiment.

FIG. 2 illustrates a timing diagram for a process for dynamically analyzing online meeting metadata within the context of a Microsoft Teams call in real-time, in accordance with at least one embodiment.

FIG. 3A illustrates a flow diagram of a process for diarization in the context of online meeting analysis in real-time, in accordance with at least one embodiment of this disclosure.

FIG. 3B illustrates a graph of diarization as provided by process shown in FIG. 3.

FIG. 4 illustrates the flow of an online meeting being analyzed by the processes shown in FIGS. 1-3A.

FIG. 5 illustrates an exemplary computer system for performing the processes shown in FIGS. 1-3A.

FIG. 6 illustrates an exemplary configuration of a client computer device shown in FIG. 5, in accordance with one embodiment of the present disclosure.

FIG. 7 depicts an exemplary configuration of a server computer device, in accordance with one embodiment of the present disclosure.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

The present disclosure introduces a system and method for analyzing online meeting metadata to extract valuable insights regarding group dynamics, group intelligence, meeting effectiveness, productivity and creativity. The system calculates metrics based on the online meeting metadata metrics. These metrics have been shown to be key meeting success indicators in scientific research in a variety of meeting contexts. By leveraging advanced data processing techniques and machine learning algorithms, the system provides detailed analyses of various aspects of online meetings, including participant speaking patterns, audio characteristics, and group performance metrics. The system thus substitutes the deficiency of online meetings in nonverbal communications with providing context and information by extracting information from the metadata of the meeting that is not available to the participants otherwise.

The system described herein comprises components for capturing, processing, and analyzing meeting metadata, as well as modules for generating reports, visualizations, and recommendations to aid in data interpretation. Key components include, but are not limited to, a Meeting Metadata Capture Module, a Data Processing and Analysis Module, a Reporting and Visualization Module, and a Recommendations Module.

The Meeting Metadata Capture Module is responsible for collecting data generated during online meetings, including participant speaking patterns, audio characteristics (such as volume, pitch, and rate of speaking), and metadata related to participant location and date/time of participation. However, for privacy reasons, the content of the meeting itself is not captured.

The Data Processing and Analysis Module utilizes machine learning algorithms and statistical techniques. The module processes the captured metadata to extract relevant insights regarding participant behavior, group dynamics, group intelligence, meeting effectiveness, productivity and creativity. The module employs techniques such as diarization to segment the audio data. The module also uses other algorithms to analyze speaking patterns and audio characteristics to assess participant engagement and communication effectiveness. The online meeting metadata metrics being calculated have been shown to be key meeting success indicators in scientific research in a variety of meeting contexts.

The Reporting and Visualization Module generates comprehensive reports and visualizations in real time, or after the meeting, summarizing the findings from the data analysis. These reports provide insights into various aspects of the online meetings, including participant speaking time, contribution levels, group intelligence and other meeting related scores. Visualizations such as graphs and charts are used to present the data in an easily interpretable format.

The Recommendations Module uses metadata of the group interaction to make recommendations to the meeting participants or other third-parties to increase the overall success of the meeting based on scientific findings. This can happen in real time during the meeting and/or after the meeting as a summary report.

As used herein, an Online Meeting is considered a synchronous communication between two or more participants via an audio or video conferencing tool.

As used herein, Meeting Metadata is data that describes data resulting from an audio or video meeting, including participant speaking patterns, audio characteristics, participant location, and date/time of participation. However, metadata does not include the content of the meeting itself.

As used herein, Diarization is a dataset of all occurrences at which a participant spoke during an audio meeting, including length (but not audio volume, pitch, and rate of speaking.)

As used herein, Group Intelligence is the performance or productivity of a team according to a test measuring team performance introduced in scientific research.

As used herein, an Audio or Video Provider is a company or service provider offering software platforms or applications enabling audio or video meetings.

As used herein, a Host UI includes user interface software provided by the party hosting the audio or video meetings.

As used herein, a Provider Specific Backend includes Backend infrastructure specific to a particular audio or video provider.

As used herein, a Host General Purpose Backend includes the Meeting host's software independent of service provider specifics.

As used herein, a Host Datastore is one or more databases where all metadata is stored.

As used herein, a processor ML (Machine Learning) is a computer program able to learn from experience with respect to some class of tasks.

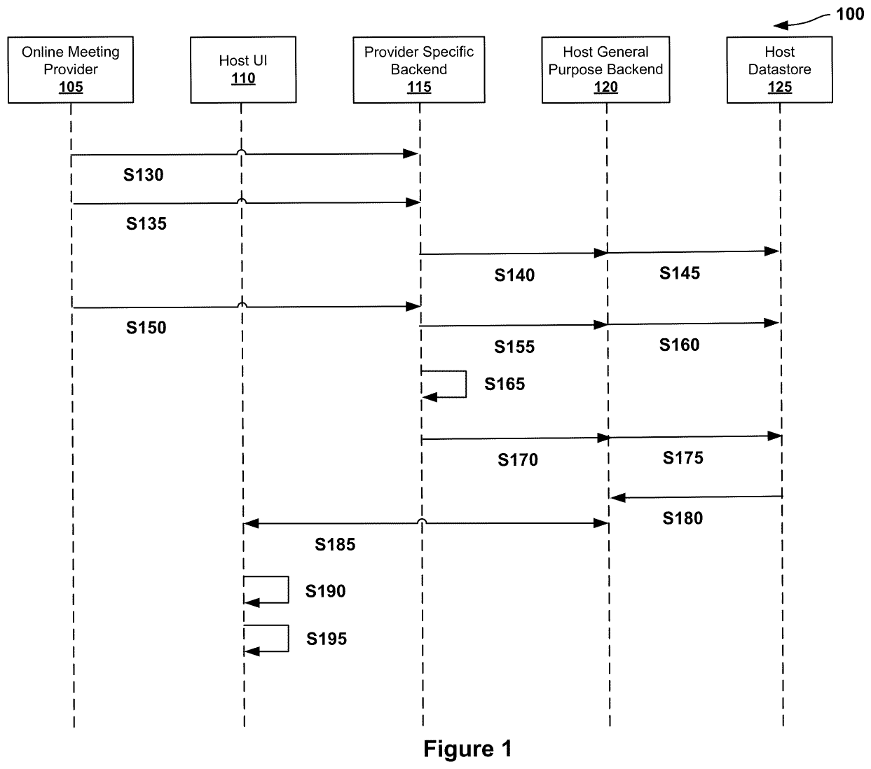

FIG. 1 illustrates a timing diagram for a process 100 for dynamically generating and analyzing metadata for online meetings in real-time, in accordance with at least one embodiment. In the example embodiment, an online meeting provider 105 is in communication with a host system. The host system facilitates the analysis of online meeting metadata by integrating various components to capture, process, and visualize data. The host system may include, but is not limited to, a host UI 110, a provider specific backend 115, a host general purpose backend 120 and at least one host datastore 125. In some embodiments, the host system is associated with one or more of the users attending the online meeting. In other embodiments, the host system is associated with a company or enterprise that is providing the online meeting or has hired the online meeting provider 105.

The online meeting provider 105 is a company or service provider offering software platforms or applications enabling audio and/or video meetings. In many embodiments, the online meeting provider 105 is in communication with a plurality of user device, where the user devices are providing communication with other user devices via the online meeting provider 105. The user devices may include an application that allows them to connect to the online meeting provider 105.

The Host UI 110 includes user interface software provided by the party hosting the audio and/or video meetings. The Provider Specific Backend 115 includes Backend infrastructure specific to a particular audio and/or video provider. The Host General Purpose Backend 120 includes the Meeting host's software independent of service provider specifics. The Host Datastore 125 is one or more databases where all metadata is stored.

In Step S130, the user initiates a call. The process 100 begins when a user initiates S130 an online meeting call through the online meeting provider's platform 105. Upon initiation of the call, the provider-specific backend component 115 extracts S135 the local date and time information of each participant involved in the meeting. In some embodiments, this information is provided by the online meeting provider 105. In Step S135, the Provider-Specific Backend Extracts 115 the Locations of Participants. Simultaneously to step S130, the provider-specific backend 115 extracts S135 the location data of participants, including geographical coordinates or other location identifiers. In Step S140, the Provider-Specific Backend 115 Sends Extracted Metadata to the General Purpose Backend 120. The extracted metadata, including local date and time and participant locations, is sent S140 to the general purpose backend 120 for further processing and then for storage S145 in the datastore 125.

In Step S150, the Online Meeting Provider 105 Continuously Sends Audio Stream data captured during the meeting to the provider specific backend 115 throughout the duration of the meeting. In Step S155, the Provider-Specific Backend 115 Sends Extracted Audio Metadata to the General Purpose Backend 120. The provider-specific backend 115 continuously extracts audio metadata such as pitch, volume, and rate of speaking from the audio stream. This extracted audio metadata is then sent S155 to the general purpose backend 120 for further analysis and to the datastore 125 for storage S160. In Step S165, the Provider-Specific Backend 115 Continuously Calculates Diarization. Diarization is the process of segmenting audio data is continuously calculated by the provider-specific backend component 115. In Step S170, the Provider-Specific Backend 115 Sends Calculated Diarization to the General Purpose Backend 120. The calculated diarization information identifies individual speakers and their respective speech segments. In Steps S170 and S175, the calculated diarization is sent to the general purpose backend 120 for subsequent analysis and to the datastore 125 for storage. Steps S150 through S175 continuously repeat as the meeting continues.

In Step S185, the UI 110 Continuously Polls for Diarization from General Purpose Backend 120. The user interface (UI) component 110 continuously polls the general purpose backend 120 to retrieve the latest diarization information stored in the datastore 125. This information may be loaded S180 from the datastore 125 as needed.

In Step S190, the UI 110 Calculates Key Performance Indicators (KPIs) Based on Received Diarization. Upon receiving the diarization data, the UI 110 calculates key performance indicators (KPIs) such as participant speaking time, contribution levels, and other relevant metrics based on the identified speaker segments. Then in Step S195, the UI 110 Visualizes Calculated KPIs and Diarization. The UI component 110 visualizes the calculated KPIs and diarization information in an easily interpretable format, such as graphs, charts, or other visualization tools, providing users with valuable insights into participant behavior and meeting dynamics. The UI component 110 additionally furnishes meeting participants and third-parties with real-time guidance, aiding in enhancing the meeting's success rate.

This detailed description of process 100 illustrates the systematic flow of operations within the system for analyzing online meeting metadata, from data capture and processing to visualization and analysis.

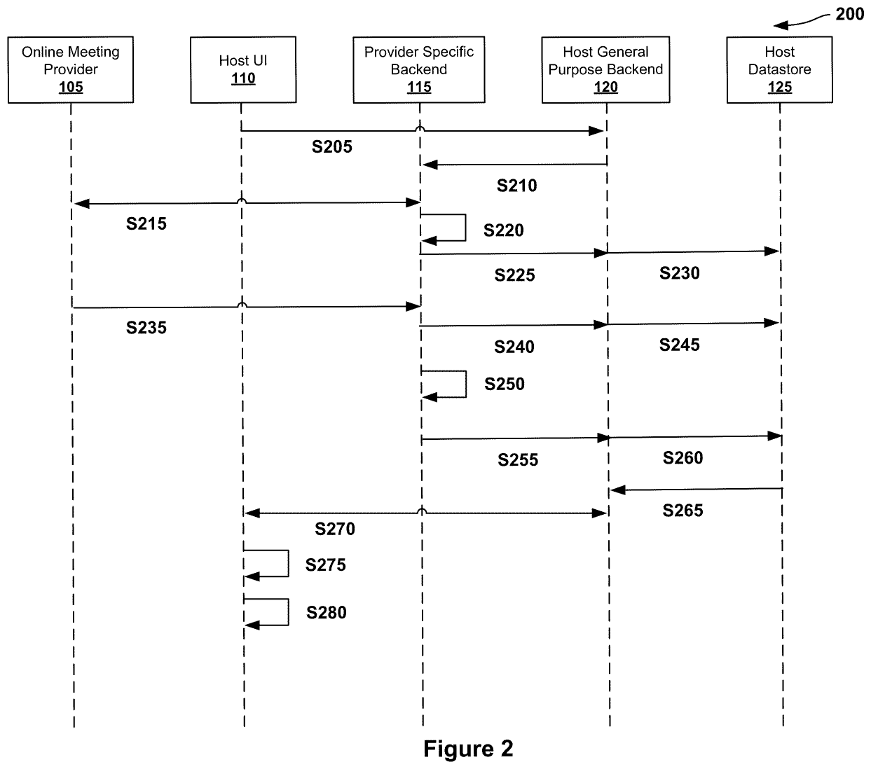

FIG. 2 illustrates a timing diagram for a process 200 for dynamically analyzing online meeting metadata within the context of a Microsoft Teams call in real-time, in accordance with at least one embodiment. One having skill in the art would have understand that process 200 could be used with other online meeting providers 105, such as, but not limited to, Zoom and Google Meetings.

In Step S205, the user requests bot to join the call. The process 200 begins when a user requests a bot to join the online meeting call, specifically within the Microsoft Teams platform. In the example embodiment, the bot is a part of the provider specific backend 115 and the general purpose backend 120. In step S210, the bot joins the call. Upon receiving the user's request, the bot joins the Microsoft Teams call, enabling its integration into the meeting environment. Then the MS Teams Bot Backend 115 extracts S215 local date and time of participants. Upon joining the call, the backend component 115 of the MS Teams bot extracts S220 the local date and time information of each participant involved in the meeting. The MS Teams Bot Backend 115 also extracts S220 location of participants. Simultaneously, the MS Teams bot backend 115 extracts S220 the location data of participants, which may include geographical coordinates or other location identifiers.

In step S225, the MS Teams Bot Backend 115 Sends S225 the extracted metadata to the general purpose backend. The extracted metadata, comprising local date and time and participant locations, is transmitted S225 from the MS Teams bot backend 115 to the general purpose backend 120 for further processing and storage S230 in the datastore 125. The MS Teams 105 Continuously Sends S235 Audio Stream per Participant. Throughout the duration of the meeting, MS Teams 105 continuously streams S235 audio data from each participant participating in the call. The MS Teams Bot Backend 115 sends S240 the extracted audio metadata to the general purpose backend 120. The backend of the MS Teams bot 1215 continuously extracts audio metadata such as pitch, volume, and rate of speaking from the audio streams of each participant. This extracted audio metadata is then transmitted S240 to the general purpose backend 120 for subsequent analysis and to the datastore 125 for storage S245.

The MS Teams Bot Backend 115 continuously calculates S250 diarization. Diarization is the process of segmenting audio data that is continuously calculated S250 by the backend component of the MS Teams bot 115. The MS Teams Bot Backend 115 sends S255 calculated diarization to the general purpose backend 120. The calculated diarization information, which delineates individual speakers and their respective speech segments, is sent from the MS Teams bot backend 115 to the general purpose backend 120 for further analysis and to the datastore 125 for storage S260.

In Step S270, the UI 110 Continuously Polls for Diarization from General Purpose Backend 120. The user interface (UI) component 110 continuously polls the general purpose backend 120 to retrieve the latest diarization information stored in the datastore 125. This information may be loaded S265 from the datastore 125 as needed.

The UI 110 Calculates S275 Key Performance Indicators (KPIs) based on received diarization. Upon receiving the diarization data, the UI 110 calculates S275 key performance indicators (KPIs) such as participant speaking time, contribution levels, and other relevant metrics based on the identified speaker segments. Then the UI 110 Visualizes S280 calculated KPIs and diarization. Finally, the UI component 110 visualizes S280 the calculated KPIs and diarization information in an easily interpretable format, such as graphs, charts, or other visualization tools, providing users with valuable insights into participant behavior and meeting dynamics. The UI component 110 additionally furnishes meeting participants and third-parties with real-time guidance, aiding in enhancing the meeting's success rate.

This detailed description of process 200 illustrates for analyzing online meeting metadata within the context of a Microsoft Teams call, with potential applicability to other online meeting platforms.

As described herein, the processes 100 and 200 for generating and analyzing metadata for online meetings is performed in real-time as the meeting is occurring to allow for real-time analysis of the meeting. This real-time analysis allows for facilitators to make changes in the meeting as the meeting is occurring to ensure that the participants are all able to participate.

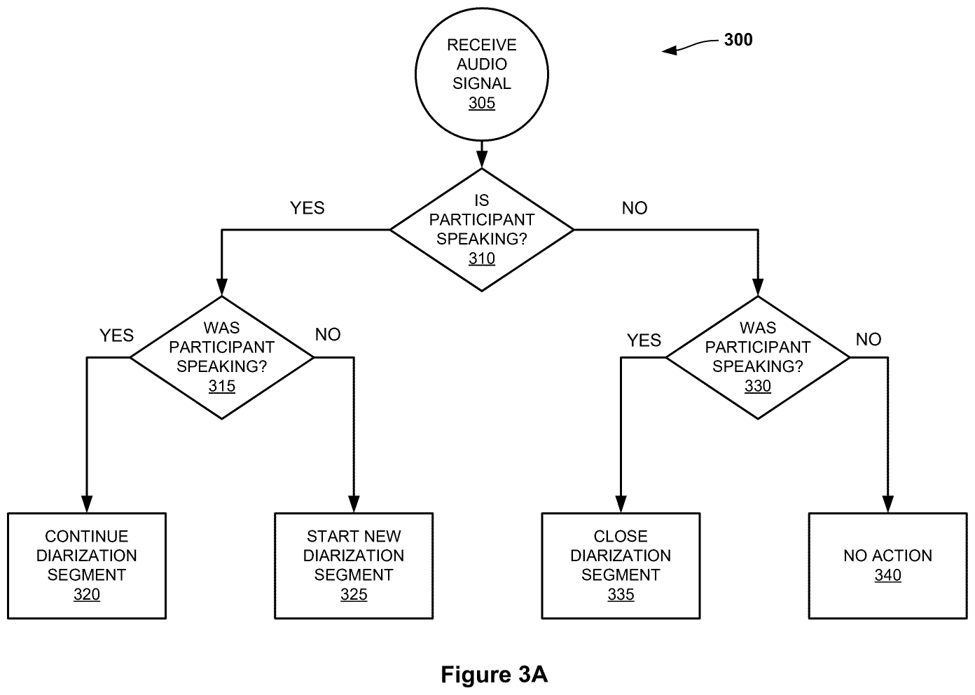

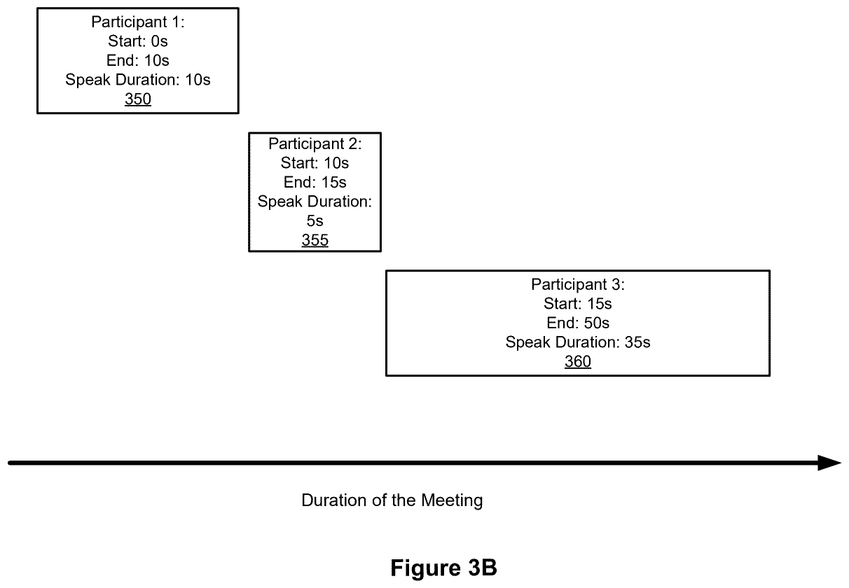

FIG. 3A illustrates a flow diagram of a process 300 for diarization in the context of online meeting analysis in real-time, in accordance with at least one embodiment of this disclosure. For this discussion diarization is the process of segmenting audio data to enable the extraction of valuable insights into participant behavior and meeting dynamics. In the example embodiment, process 300 is performed by the provider specific backend 115 (shown in FIG. 1).

In the example embodiment, the provider specific backend 115 receives 305 the Audiostream from online meeting platform 105 (shown in FIG. 1) per participant. This is similar to step S150 (shown in FIG. 1) and step S235 (shown in FIG. 2). The rest of the steps of process 300 are part of set S165 (shown in FIG. 1) and step S250 (shown in FIG. 2).

The provider specific backend 115 checks 310 if participant is speaking. If yes, the provider specific backend 115 checks 315 if participant was speaking before. If yes, the provider specific backend 115 continues 320 the current diarization segment. If the participant was not speaking, then the provider specific backend 115 starts 325 a new diarization segment. If the participant is not speaking, the provider specific backend 115 checks 330 if participant was speaking before. If yes, the provider specific backend 115 closes 335 the current diarization segment. If no one was speaking before, the provider specific backend 115 takes 340 no action.

In the example embodiment, the determination if the Participant is Speaking is done with state of the art “Voice activity detection” mechanisms and programs.

By dynamically adjusting diarization segments based on participant speech activity, the system improves the accuracy and efficiency of online meeting analysis. Additionally, real-time diarization and analysis of meeting metadata enables the system to provide timely insights into participant behavior and meeting dynamics, enhancing the overall effectiveness of the online meeting analysis process.

FIG. 3B illustrates a graph of diarization as provided by process 300 (shown in FIG. 3). The first segment 350 shows that the first participant spoke for 10 seconds. The second segment 355 shows that the second participant spoke for five seconds. And the third segment shows 35 seconds. In some embodiments, there may be blank areas were no participant spoke. In other embodiments, there may bmultiple segments for the same participant.

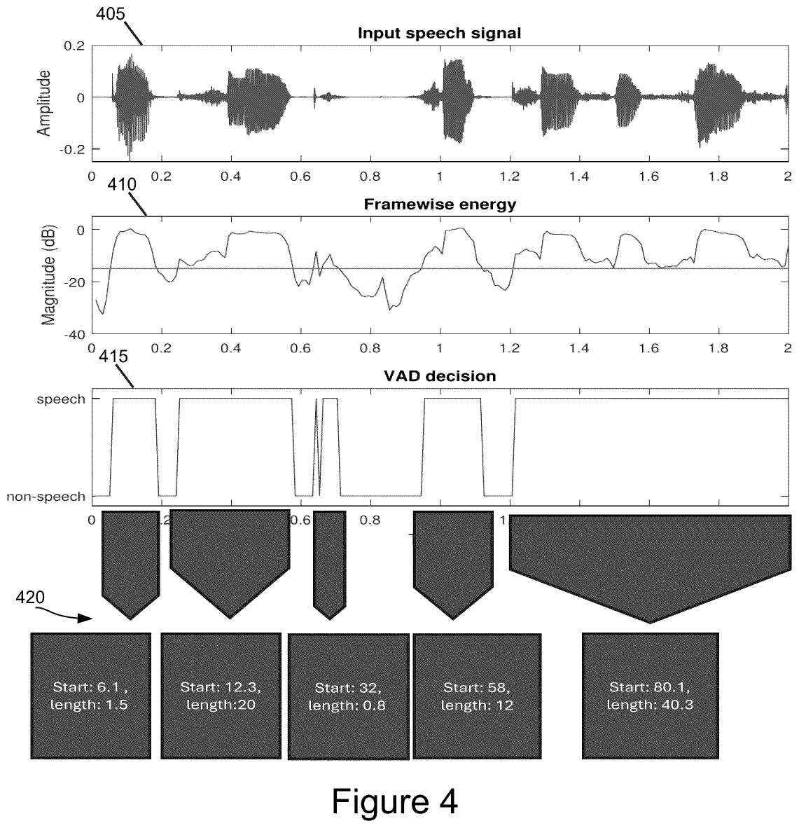

FIG. 4 illustrates the flow of an online meeting being analyzed by the processes 100-300 (shown in FIGS. 1-3A). A first graph 405 illustrates the amplitude of the participant speaking. A second graph 410 illustrates the magnitude of the participant speaking. A third graph 415 illustrates detecting period so speech and no speech. The last section 420 shows the various segments that were determined for diarization.

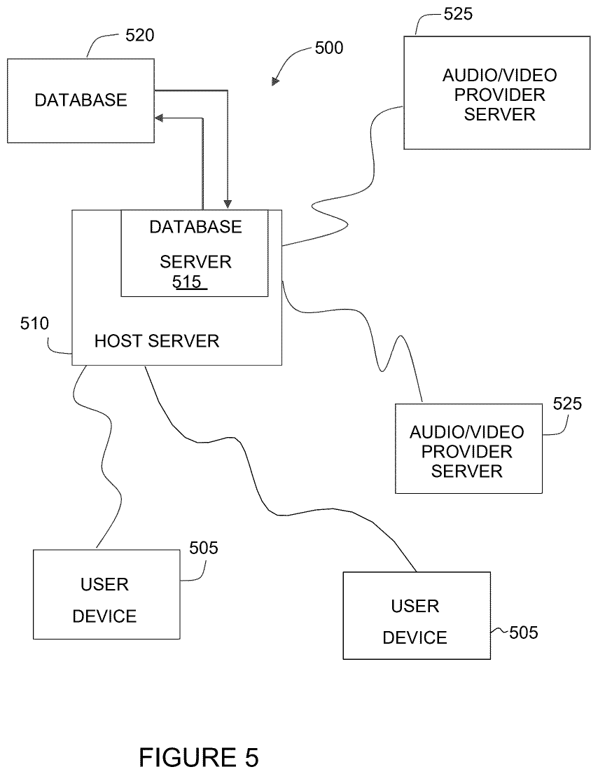

FIG. 5 illustrates an exemplary computer system 500 for performing the processes 100-300 (shown in FIGS. 1-3A). In the exemplary embodiment, the system 500 is used for generating and analyzing metadata for online meetings.

As described below in more detail, the Host server 510 may be programmed for generating and analyzing metadata for online meetings. In some embodiments, the host server 510 may be programmed to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyzing the diarization information to calculate one or more key performance indicators; and e) generate visualization of the key performance indicators to be displayed to one or more participants in the online meeting.

In the example embodiment, user devices 505 are computers that include a web browser or a software application, which enables user devices 505 to communicate with host server 510 using the Internet, a local area network (LAN), or a wide area network (WAN). In some embodiments, the user devices 505 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 505 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the host server 510 is a computer that include a web browser or a software application, which enables host server 510 to communicate with user devices 505 using the Internet, a local area network (LAN), or a wide area network (WAN). Furthermore, the host server 510 may include a host UI 110, a provider specific backend 115, a host general purpose backend 120 and at least one host datastore 125 (all shown in FIG. 1). In some embodiments, the host server 510 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The host server 510 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 515 is communicatively coupled to a database 520 that stores data. In one embodiment, the database 520 is a database that includes diarization data and metadata from online meetings. In some embodiments, the database 520 is stored remotely from the host server 510. In some embodiments, the database 520 is decentralized. In the example embodiment, a person can access the database 520 via the user devices 505 by logging onto host server 510. In some embodiments, the database 520 is similar to, or in communication with, the datastore 125.

Audio/Video provider servers 525 may be any third-party server to provide information that host server 510 is in communication with that provides additional functionality and/or information to host server 510. For example, Audio/Video provider servers 525 may be similar to online meeting providers 105 (shown in FIG. 1). In the example embodiment, Audio/Video provider servers 525 are computers that include a web browser or a software application, which enables Audio/Video provider servers 525 to communicate with the host server 510 using the Internet, a local area network (LAN), or a wide area network (WAN).

In some embodiments, the Audio/Video provider servers 525 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Audio/Video provider servers 525 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

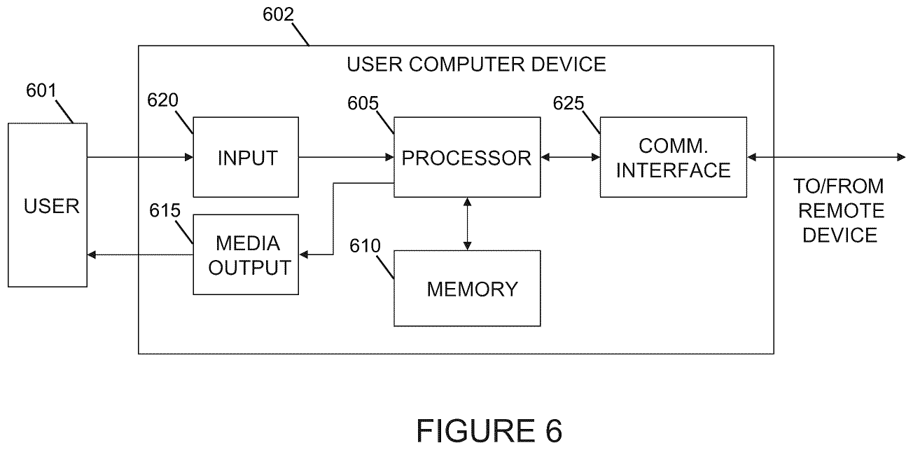

FIG. 6 depicts an exemplary configuration 600 of user computer device 602, in accordance with one embodiment of the present disclosure. In the exemplary embodiment, user computer device 602 may be similar to, or the same as, user device 505 (shown in FIG. 5). User computer device 602 may be operated by a user 601.

User computer device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 615 may be configured to present a graphical user interface (e.g., a web browser and/or a client application) to user 601. A graphical user interface may include, for example, an interface for viewing items of information provided by the host server 510 (shown in FIG. 5). In some embodiments, user computer device 602 may include an input device 620 for receiving input from user 601. User 601 may use input device 620 to, without limitation, provide information either through speech or typing.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as host server 510. Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from Host server 510. A client application may allow user 601 to interact with, for example, Host server 510. For example, instructions may be stored by a cloud service, and the output of the execution of the instructions sent to the media output component 615.

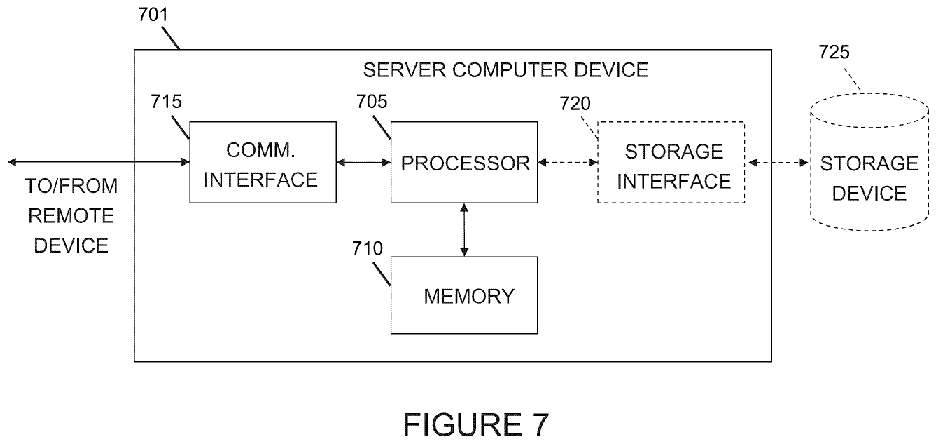

FIG. 7 depicts an exemplary configuration 700 of a server computer device 701, in accordance with one embodiment of the present disclosure. In the exemplary embodiment, server computer device 701 may be similar to, or the same as, online meeting provider 105, host UI 110, a provider specific backend 115, a host general purpose backend 120 (all shown in FIG. 1), host server 510, database server 515, and audio/video provider server 525 (all shown in FIG. 5). Server computer device 701 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 is capable of communicating with a remote device such as another server computer device 701, Host server 510, audio/video provider server 525, and user devices 505 (shown in FIG. 5) (for example, using wireless communication or data transmission over one or more radio links or digital communication channels). For example, communication interface 715 may receive input from user devices 505 via the Internet, as illustrated in FIG. 5.

Processor 705 may also be operatively coupled to a storage device 725. Storage device 725 may be any computer-operated hardware suitable for storing and/or retrieving data, such as, but not limited to, data associated with one or more models. In some embodiments, storage device 725 may be integrated in server computer device 701. For example, server computer device 701 may include one or more hard disk drives as storage device 725.

In other embodiments, storage device 725 may be external to server computer device 701 and may be accessed by a plurality of server computer devices 701. For example, storage device 725 may include a storage area network (SAN), a network attached storage (NAS) system, and/or multiple storage units such as hard disks and/or solid-state disks in a redundant array of inexpensive disks (RAID) configuration.

In some embodiments, processor 705 may be operatively coupled to storage device 725 via a storage interface 720. Storage interface 720 may be any component capable of providing processor 705 with access to storage device 725. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 725.

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instruction such as illustrated in FIGS. 1-3A.

In some embodiments, the host system includes a meeting metadata capture module configured to collect data generated during online meetings, including participant speaking patterns and audio characteristics. The host system also includes a data processing and analysis module configured to process the captured metadata using machine learning algorithms and statistical techniques to extract insights regarding participant behavior and group dynamics and generate meeting success indicators. The host system further includes a reporting and visualization module configured to generate reports and visualizations summarizing the findings from the data analysis. In addition the host system includes a recommendation module configured to provide recommendations to increase the overall success of the meeting based on scientific findings in real time during the meeting and/or after the meeting as a summary report.

In some embodiments, the meeting metadata capture module further captures metadata related to participant location and date/time of participation.

In some embodiments, the data processing and analysis module employs diarization techniques to segment the audio data. Based on this data metrics are being calculated that have shown to be key meeting success indicators in scientific research in a variety of meeting contexts.

In some embodiments, the reporting and visualization module generates visualizations such as graphs and charts to present the analyzed data in an easily interpretable format.

In some embodiments, the reporting and visualization module furnishes meeting participants and third-parties with real-time guidance or analysis after the meeting, aiding in enhancing meeting success rates.

In conclusion, the system and method for dynamic diarization and analysis of meeting metadata in online meeting analysis represent a significant advancement in the field of audio processing and online meeting analytics. The invention has numerous applications across various domains, including remote collaboration, communication analysis, and performance evaluation in virtual environments.

### ADDITIONAL CONSIDERATIONS

Example embodiments of compressor systems and methods, such as refrigerant compressors, are described above in detail. The systems and methods are not limited to the specific embodiments described herein, but rather, components of the system and methods may be used independently and separately from other components described herein. For example, the cooling circuits described herein may be used in compressors other than centrifugal compressors, including, for example and without limitation, scroll compressors, rotary compressors, and reciprocating compressors.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for dynamically generating and analyzing metadata for online meetings, the system comprising a computer device comprising at least one processor in communication with at least one memory device, wherein the at least one memory device stores computer-implemented instructions that cause the at least one processor to:
receive at least one stream of at least one of audio and video of an online meeting, wherein the at least one stream includes one or more participants participating in the online meeting;
extract a plurality of metadata from the at least one stream;
perform diarization on the at least one stream and the plurality of metadata the at least one stream to generate diarization information, wherein the diarization information includes information about participation for the one or more participants in the online meeting;
analyze the diarization information to calculate one or more key performance indicators; and
generate visualization of the key performance indicators to be displayed to one or more participants in the online meeting.

2. The system of claim 1, further comprising:
a meeting metadata capture module configured to collect data generated during online meetings, including participant speaking patterns and audio characteristics;
a data processing and analysis module configured to process the captured metadata using machine learning algorithms and statistical techniques to extract insights regarding participant behavior and group dynamics and generate meeting success indicators; and
a reporting and visualization module configured to generate reports and visualizations summarizing the findings from the data analysis.
a recommendation module configured to provide recommendations to increase the overall success of the meeting based on scientific findings in real time during the meeting and/or after the meeting as a summary report.

3. The system of claim 2, wherein the meeting metadata capture module further captures metadata related to participant location and date/time of participation.

4. The system of claim 2, wherein the data processing and analysis module employs diarization techniques to segment the audio data. Based on this data metrics are being calculated that have shown to be key meeting success indicators in scientific research in a variety of meeting contexts.

5. The system of claim 2, wherein the reporting and visualization module generates visualizations such as graphs and charts to present the analyzed data in an easily interpretable format.

6. The system of claim 2, wherein the reporting and visualization module furnishes meeting participants and third-parties with real-time guidance or analysis after the meeting, aiding in enhancing meeting success rates.
